(19) United States
(12) Patent Application Publication
(10) Pub. No.: US 2020/0024703 A1
(43) Pub. Date: Jan. 23, 2020

(54) NICKEL AND CHROME BASED IRON ALLOY HAVING ENHANCED HIGH TEMPERATURE OXIDATION RESISTANCE

(71) Applicant: BorgWarner Inc., Auburn Hills, MI (US)

(72) Inventors: Gerald SCHALL, Bobenheim-Roxheim (DE); Ingo DIETRICH, Gruenstadt (DE)

(21) Appl. No.: 16/490,666

(22) PCT Filed: Feb. 27, 2018
(86) PCT No.: PCT/US2018/019825

§ 371 Date: Sep. 3, 2019

Related U.S. Application Data
(60) Provisional application No. 62/466,429, filed on Mar. 3, 2017.

(51) Int. Cl. C22C 30/00; F01D 9/02

(52) U.S. Cl. CPC C22C 30/00; F01D 9/026; F05D 2300/13; F05D 2230/211; F05D 2300/111; F05D 2220/40

(57) ABSTRACT

A nickel- and chrome-rich highly heat-resistant, austenitic iron based alloy. The alloy exhibits an improved fine dendritic carbide structure and can withstand repeated thermal elongation and strain which is particularly important for an exhaust-gas turbocharger component exposed to exhaust gas flow, such as a turbine housing. The alloy also guarantees very good thermo-mechanical fatigue (TMF) loading performance. A thermal cracking problem of the component is significantly reduced. The alloy is influenced by the relationship between the elements nickel, niobium, cerium and vanadium. The invention further concerns a method for prevention of crack formation and for minimizing oxidization in a turbocharger turbine housing.

### BACKGROUND OF THE INVENTION

### Field of the Invention

The invention relates to a nickel- and chrome-rich highly heat-resistant, austenitic iron based alloy. The alloy exhibits an improved fine dendritic carbide structure and can withstand repeated thermal elongation and strain which is particularly important for an exhaust-gas turbocharger component exposed to exhaust gas flow, such as a turbine housing. The alloy also guarantees very good thermo-mechanical fatigue (TMF) loading performance. A thermal cracking problem of the component is decisively influenced The inventive alloy is influenced by the relationship between the elements nickel, niobium, cerium and vanadium. The invention further concerns a method for prevention of crack formation and for minimizing oxidization in a turbocharger turbine housing.

### Description of the Related Art

Exhaust-gas turbochargers extract energy from engine exhaust gases to drive a compressor to increase the throughput of combustible mixture per working stroke, thereby achieving in a smaller engine the performance of a larger displacement engine. Extremely high demands are made on the material of the turbocharger. These materials must exhibit corrosion resistance, oxidation resistance, crack resistance, and must maintain dimensional stability, and in particular exhibit good thermo-mechanical fatigue (TMF) loading performance, even at very high temperatures of up to about 1100° C.

Due to uneven temperature distribution, powerful thermal-mechanical forces act on the turbine housing. The heat field within a turbine housing is angularly and radially uneven. In an angular sense, the hottest part of the turbine housing is at the turbine foot, where the exhaust gas enters the turbine housing, and the temperature cools as the volute diminishes towards the tongue. In a radial sense, the temperature increases as the exhaust gas flows from the roof of the volute toward the wheel. Graphically, the turbine housing is coiled like a snail shell. Structurally, the geometry and wall thickness of the turbine housing vary considerably. As a result of these design and thermal disparities, thermal forces tend to make the snail shell try to unwind and, if the volute is constrained in any manner, to twist. In the case of a divided volute turbine housing, the divider wall, along with the side walls, constrains the volute from unwinding. The divider wall, while constrained at its largest diameter in that it is joined to the volute wall, is unconstrained at its inner diameter, where it also tapers. This tapered region is particularly susceptible to tensile loads from thermal stresses, which manifest themselves as generally radial cracks. Further, because the divider wall has lower thermal mass than do the other generally parallel walls, the divider wall both heats and cools more rapidly; which generates greater low cycle fatigue in the divider wall and hence increases the propensity for cracking. Further, as can be seen in FIG. 1, in the case that the turbine volute is divided by at least one divider wall for maintaining pulse separation, the internal surface area exposed to exhaust gas flow increases dramatically. Pulse-separation also increases the instability of the flow through turbine housing. As pressure pulses travel through the volute, vibrational stresses may cause any surface oxidized layer to break free, which may result in damage to the turbine wheel. For these reasons, a higher degree of resistance to oxidation would be beneficial.

One solution to this problem is disclosed in US Patent Application 20150023788, assigned to the present assignee, wherein the propensity of the turbocharger turbine divider wall to crack in the turbine housing is minimized by matching the mass of the divider wall more closely to the transient heat transfer between said divider wall and the exhaust gas flowing past it. This is achieved by providing said divider wall having a cross-sectional shape defined substantially by a Log² curve. However, this solution is applicable only to the region of the inner diameter of the divider wall. Cracking can occur anywhere in a turbine housing. There is a need for improving the TMF loading performance of a turbine housing as a whole.

U.S. Pat. No. 9,359,938 (Schall) teaches an austenitic iron-based material having a carbide structure distinguished by a very good resistance to friction wear. The alloy comprises the elements carbon (C) 0.1 to 0.5% by weight, chromium (Cr) 20 to 28% by weight, manganese (Mn) with at most 1.3% by weight, silicon (Si) 0.5 to 1.8% by weight, niobium (Nb) 0.5 to 2.0% by weight, tungsten (W) 0.8 to 4.0% by weight, vanadium (V) 0 to 1.8% by weight, nickel (Ni) 20 to 28% by weight, and iron (Fe) as the remainder. However, there is a need for further improvement in thermo-mechanical fatigue (TMF) loading performance.

There is also a need for improving the corrosion resistance and oxidation resistance of the turbine housing, as well as improving dimensional stability and high-temperature strength, as well as creep strength and fracture strength.

### BRIEF SUMMARY OF THE INVENTION

The object is achieved by a highly heat-resistant iron-based alloy, exhibiting high temperature oxidation resistance and long life when used in temperature applications up to 1100° C., having an austenitic base structure comprising an improved fine dendritic carbide structure. At the same time, elements such as chromium (Cr), vanadium (V), nickel (Ni) and niobium (Nb) ensure good thermal performance. Due to the fine carbide precipitates NbC, the microstructure is stabilized in the grain by granular corrosion. The desired oxidation resistance is imparted by the elements chromium (>25% free chromium at the grain boundary), silicon, aluminum and cerium. The characteristic of a dynamically tolerable elongation at high temperature is particularly applicable for a turbine housing, although the invention is not limited thereto. In the present alloy this property is imparted by the elements nickel, niobium, cerium and vanadium. At the same time, these elements (Ni, Cer, Nb, V) also guarantee very good TMF performance. Thus, the thermal cracking problem on the component is decisively reduced. The material composition is free of sigma phases (embrittlement phases) up to 1080° C. At the same time, this alloy provides resistance to intercrystalline corrosion.

Nitrogen is a gas at room temperature and in the alloying art is not generally employed as an alloying element. According to conventional wisdom, when nitrogen is included as an alloying element, it is included only in small amounts. See Babakr et al, “Sigma Phase Formation and Embrittlement of Cast Iron-Chromium-Nickel (Fe—Cr—Ni) Alloys”, Journal of Minerals & Materials Characterization & Engineering, Vol. 7, No.2, pp 127-145, 2008 which completely disregards nitrogen as a factor.

Creep behavior and degradation of creep properties of high-temperature materials are phenomena of major practical relevance, often limiting the lives of components and structures designed to operate for long periods under stress at elevated temperatures. U.S. Pat. No. 9,181,597 (Hawk et al) teaches a 650° C. creep resistant alloy having an overall composition of (in wt.%) 9.75 to 10.25, chromium, 1.0 to 1.5, molybdenum, 0.13 to 0.17 carbon, 0.25 to 0.50 manganese, 0.08 to 0.15 silicon, 0.15 to 0.30 nickel, 0.15 to 0.25 vanadium, 0.05 to 0.08 niobium, 0.015 to 0.035 nitrogen, 0.25 to 0.75 tungsten, 1.35 to 1.65 cobalt, 0.20 to 0.30 tantalum, 70 ppm to 110 ppm boron, the rest iron and potentially additional elements. Hawk et al teach that nitrogen in the presence of carbon combines with vanadium and niobium to form carbonitrides, which are effective to improve creep rupture strength and are extremely stable thermally. Vanadium combines with carbon and nitrogen to form finely dispersed precipitates such as V(C,N), which are stable at high temperature for an extended period of time and effective for improving long-term creep rupture strength. Niobium, like vanadium, combines with carbon and nitrogen to form fine precipitates such as Nb (C, N) which are effective to improve creep rupture strength. Nitrogen added to steel increases creep rupture strength up to 0.07% by weight after which the effect diminishes. Furthermore, nitrogen stabilizes austenite and greatly mitigates the formation of sigma-ferrite. Nitrogen at a level greater than 0.01% by weight facilitates these effects. However, increasing nitrogen content to a level greater than 0.08% by weight may degrade formability and weldability through the formation of coarse nitrides particles, and from gas pockets and voids during solidification of the ingot, which gas pockets and voids subsequently open during hot working leading to additional defects. Creep rupture strength is correspondingly lowered as is ductility and toughness. Therefore, nitrogen content should be limited to within the range 0.015-0.035 wt. %.

U.S. Pat. No. 6,761,854 (Smith et al) teach a high temperature corrosion resistant nickel-base alloy. The alloy may contain nitrogen in the amount of at least 0.01 weight percent each serve to stabilize the oxide scale and contribute toward oxidation resistance, but nitrogen levels above 0.1 wt % deteriorate the mechanical properties of the alloy.

Contrary to the conventional wisdom according to which mechanical properties of alloys are deteriorated due to formation of coarse nitrides particles, lowering creep rupture strength, ductility and toughness, in the alloy according to the present invention, when nitrogen content is above 0.1 wt %, the present inventor surprisingly discovered that addition of nitrogen in the range of from 0.1 to 0.2 wt %, in an alloy comprising elements specified below, in the specified amounts, improved high temperature oxidation resistance and improved the fine dendritic carbide structure of an iron based alloy, thereby guaranteeing very good TMF performance. Thereby, the thermal cracking problem in components such as turbocharger housings used in high-temperature environments is significantly reduced

### BRIEF DESCRIPTION OF THE SEVERAL VIEWS OF THE DRAWINGS

The present invention is illustrated by way of example and not by limitation in the accompanying drawings in which like reference numbers indicate similar parts and in which:

FIG. 1 depicts a section of a prior art divided volute turbine housing of a turbocharger assembly;

FIG. 2 depicts a cross-section of the turbine housing along section line 2-2;

FIG. 3 is a pictomicrograph of the oxidation layer of formed on an inventive alloy exposed to simulated exhaust

FIG. 4 is a pictomicrograph of the oxidation layer of formed on a comparative alloy exposed to simulated exhaust.

### DETAILED DESCRIPTION OF THE INVENTION

### Oxidation Resistance

In a radial flow turbocharger turbine, the exhaust gas stream flows, perpendicular to an axis of rotation, into a circumferential volute, which forms a narrowing spiral adapted turn the exhaust gas inwardly towards the turbine wheel and around the axis of rotation. The volute, sometimes visualized as a “snail shell,” can be classified as open (single volute) or divided (multiple volutes).

Open volutes are useful in constant-pressure turbocharging, where the pulses from the exhaust manifold of the engine are allowed to mix and where peaks and valleys average, so that the turbine wheel is driven by gas mass flow rate and temperature drop, providing relatively steady state exhaust gas to the turbine wheel. However, constant-pressure turbocharging does not take advantage of the instantaneous kinetic energy available at the peak of each pressure pulse.

To harness the instantaneous kinetic energy available at the peak of each pressure pulse, it is necessary to maintain separation between pulses from interfering cylinders in the exhaust flow, all the way from the cylinder outlet ports to the turbine wheel. In particular, it is known to employ what is known as “pulse separation” wherein the cylinders of the engine are divided into a plurality of subgroups, and the pulses from each subgroup of cylinders are substantially isolated from those of the other subgroups by having independent exhaust passages for each subgroup. A higher turbine pressure ratio is reached in a pulse separated turbine in a shorter time when extracting energy from the pressure pulsations. Through the increased pressure ratio, the efficiency increases, improving the all-important time interval when a high, more efficient mass flow is passing through the turbine. As a result of this improved exhaust gas energy utilization, the engine's boost pressure characteristics and, hence, torque behavior is improved, particularly at low engine speeds.

To maintain pulse separation from turbine foot to turbine wheel, the turbine volute must be divided into two or more flow channels using at least one divider wall. The turbine may be meridionally divided, known as twin-flow, in which the two channels are arranged adjacent to one another and, at least along an arc-shaped segment, each enclosing the turbine wheel in spiral form at equal (at least overlapping) radii. Alternatively, the divided turbine may be a dual-flow, where two channels are arranged in each case feeding a different arc-shaped segment, for which reason said dual-flow turbines are also often referred to as segmented turbines. The turbine housing may be an axial flow design, or any design. As used herein, the terms “twin-flow”, “dual-flow” will be used interchangeably.

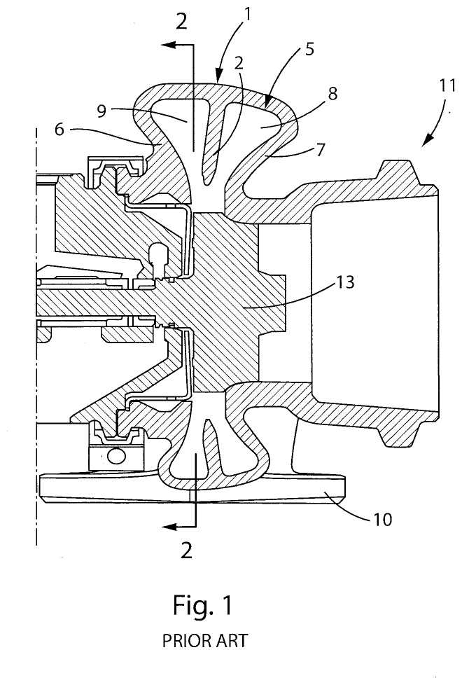

As can be seen in FIG. 1, the total surface area inside a volute increases dramatically as the volute is divided by at least one divider wall into two or more volutes. As the surface area increases, there is a greater area for deposit of soot. Further, as the surface area whetted by corrosive exhaust is increased, so is the exposure to oxidation events. While pulse-separation increases the available energy, it also increases the instability of the flow through turbine housing. As pulses travel through the volute, vibrational stresses may cause soot or scale or any oxidized layer on the volulte walls to break free. These free oxides may damage the blades of the turbine wheel. It is thus important to prevent oxidization of the inner walls of the volute. The present invention provides a highly oxidation resistant oxide for an exhaust gas turbocharger turbine housing.

### Crack Prevention

As can be seen in FIG. 1, flow segregation can be maintained in the turbine housing volute (1) by the use of a divider wall (2). The divider wall (2) has a tip (3) and a root (4) and divides flow into a first flow passage (8) and a second flow passage (9). The volute (1) has a roof (5), a first sidewall (6) and a second sidewall (7).

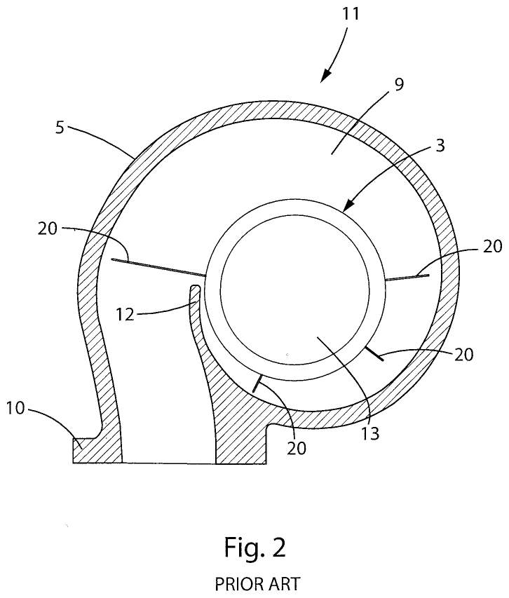

As shown in FIG. 2, in an angular sense, the hottest part of the turbine housing (11) is at the turbine foot (10), where the exhaust gas enters the turbine housing. The temperature of the exhaust gas cools as the flow passage (9) diminishes towards the tongue (12). In a radial sense, the temperature increases from the roof (17) of the volute toward the turbine wheel (13). Graphically, the turbine housing (11) is coiled like a snail shell. Structurally, the geometry and wall thickness of the turbine housing vary considerably. As a result of these shape, mass and thermal disparities, thermal forces tend to make the snail shell try to unwind and, if the volute is constrained in any manner, to twist. In the case of a divided volute turbine housing, the divider wall (2), along with the side walls (6, 7), constrains the volute from unwinding. The divider wall (2), while constrained at its largest diameter in that it is joined to the volute roof (5), is unconstrained at its inner diameter, the tip (3), where it also tapers. This tapered region is particularly susceptible to tensile loads from thermal stresses, which over time manifest themselves as generally radial cracks (20). Further, because the divider wall (2) has lower thermal mass than do the other generally parallel walls (6, 7), the divider wall (2) both heats and cools more rapidly; which generates greater low cycle fatigue in the divider wall and hence increases the propensity for cracking.

The alloy of the present invention is characterized by a set of properties rendering it particularly suitable for components exposed to very high temperatures, uneven temperature distribution, corrosive atmosphere, and repeated thermal cycling. One particular application is turbocharger housings as just discussed. The alloy is resistant to exhaust gases produced by Diesel or Otto engines and can be used in turbine housings with and without manifolds. The alloy is castable and exhibits high temperature oxidation resistance and TMF resistance as well as dimensional stability up to 1100° C.

The micro-structure of the material composition shows an austenitic basic structure with a fine network of carbide formations. Wear resistance is provided by a carbide structure. Phase exclusions of rare earths within the grain structure generate atomic bonding chains within the matrix. Also, phase exclusions of rare earths within the grain structure generate atomic bonding chains within the matrix. Thereby, the lattice-sliding is significantly reduced and thus the LCF and TMF performance is increased. That is, in a pure metal, a crystal lattice of metals consists of ions (not atoms) surrounded by a sea of electrons. The outer electrons (−) from the original metal atoms are free to move around between the positive metal ions formed (+). These ‘free’ or ‘delocalised’ electrons from the outer shell of the metal atoms are the ‘electronic glue’ holding the particles together. There is a strong electrical force of attraction between these free electrons (mobile electrons or ‘sea’ of delocalised electrons) (−) and the ‘immobile’ positive metal ions (+) that form the giant lattice and this is the metallic bond. When exposed to stress, the lattice layers can slide over each other and the bonding is maintained as the mobile electrons keep in contact with ions of the lattice, providing malleability and ductility. Alloys are not usually considered as compounds (despite the fact that all the atoms are chemically bonded together), but described as a physical mixing of a metal plus at least one other material which may be a metal (e.g., chromium, nickel) or non-metal (carbon, nitrogen). (shown by red circle). The presence of the other atoms (smaller or bigger) disrupts the symmetry of the layers and this distortion reduces the ‘slip ability’ of one layer to slide next to another layer of metal atoms, resulting in a stronger harder less malleable metal, but one better suited to most purposes. Carbon in steels forms carbides—particularly a carbide of Fe—cementite (Fe3C). Carbides are hard themselves, but dispersed in steel, they strengthen the alloy by dispersion strengthening, which as mentioned prevents the glide of dislocations and sliding/slipping of atoms in the lattice. In grain-boundary strengthening, the grain boundaries act as pinning points impeding further dislocation propagation. Since the lattice structure of adjacent grains differs in orientation, it requires more energy for a dislocation to change directions and move into the adjacent grain. The grain boundary is also much more disordered than inside the grain, which also prevents the dislocations from moving in a continuous slip plane. Impeding this dislocation movement. Another form of grain boundary strengthening is achieved through the addition of carbon and a carbide former, such as Cr, Mo, W, Nb, Ta, Ti, or Hf, which drives precipitation of carbides at grain boundaries and thereby reduces grain boundary sliding. Under an applied stress, existing dislocations and dislocations will move through a crystalline lattice until encountering a grain boundary, where the large atomic mismatch between different grains creates a repulsive stress field to oppose continued dislocation motion. As more dislocations propagate to this boundary, dislocation ‘pile up’ occurs as a cluster of dislocations are unable to move past the boundary. As dislocations generate repulsive stress fields, each successive dislocation will apply a repulsive force to the dislocation incident with the grain boundary. These repulsive forces act as a driving force to reduce the energetic barrier for diffusion across the boundary, such that additional pile up causes dislocation diffusion across the grain boundary, allowing further deformation in the material. Decreasing grain size decreases the amount of possible pile up at the boundary, increasing the amount of applied stress necessary to move a dislocation across a grain boundary. The higher the applied stress needed to move the dislocation, the higher the yield strength. Thus, there is then an inverse relationship between grain size and yield strength. Obviously, there is a limit to this mode of strengthening, as infinitely strong materials do not exist. Grain sizes can range from about 100 μm (large grains) to 1 μm (small grains). Lower than this, the size of dislocations begins to approach the size of the grains. At a grain size of about 10 nm, only one or two dislocations can fit inside a grain. This scheme prohibits dislocation pile-up and instead results in grain boundary diffusion. The lattice resolves the applied stress by grain boundary sliding, resulting in a decrease in the material's yield strength.

Increasing nitrogen content to a level greater than 0.08% by weight may degrade formability through the formation of coarse nitrides particles. Creep rupture strength is correspondingly lowered as is ductility and toughness.

The alloy according to the present invention is a chemically modified, highly heat-resistant, austenitic alloy, intended for a temperature applications up to 1100° C. The alloy has high resistance to high temperature oxidation and exhibits an improved fine dendritic carbide structure. Elements such as chromium (Cr), vanadium (V), nickel (Ni) and niobium (Nb) ensure good thermal properties. Due to the fine carbide precipitates such as NbC, the grain microstructure is stabilized against IK corrosion. The desired oxidation resistance is imparted by the element chromium (>25% free chromium at the grain boundary), silicon, aluminum and cerium. The characteristic of a dynamically tolerable elongation at the above-referenced component temperature is particularly important when the alloy is used for forming a turbine housing. This property is ensured by the elements nickel, niobium, cerium and vanadium. At the same time, these elements (Ni, Cer, Nb, V) also guarantee very good TMF performance. Thus, the thermal cracking problem on the component is decisively reduced.

The following chemical elements are contained in this alloy:

Carbon (C) imparts a higher strength due to the formation of carbide formations and is also used to generate a higher heat resistance.

Chromium (Cr) imparts an increase in hot tensile strength and scale resistance. At the same time, chromium is a strong carbide former, type M23C6, which reflects its advantages in wear behavior. Furthermore, valuable Cr₂0₃ topcoats are formed upon exposure to very high exhaust gas temperatures, which topcoats result in very good resistance to sliding wear.

Manganese (Mn) further expands the gamma range of the material. The yield strength and tensile strength are increased by manganese addition. At the same time, the wear resistance at high temperature is increased.

Niobium (Nb) and vanadium (V) are here used as carbide formers, type MC. The elements are ferrite formers and thus reduce the gamma range. Further, the hot strength and the creep strength are increased.

Silicon (Si) reduces the viscosity of the melt during casting. In addition, the element causes deoxidation, which significantly improves the resistance to hot gas corrosion by alloying.

Nickel (Ni) causes an improvement in ductility and heat resistance. The higher nickel content is necessary in order to impart resistance to cracks due to temperature change.

Boron (B) has a positive effect on the pourability and also reduces the casting defects in the micro-cavity area. Such discontinuities in turn are responsible for the fact that twist and vibration fractures and cracks progress from the inner (turbine housing spiral channel) to the outer skin.

Cer (Ce) has a strong oxygen-reducing effect in the melt and improves the scale resistance in the heat-resistant steel. Furthermore, this element ensures that the thermal cracking tendency during operation is significantly reduced.

Nitrogen (N) forms nitrides and widens the austenite range of this alloy while reducing oxygen-induced corrosion and oxidation rates. This reduces, among other things, the high-temperature corrosive attack. Nitrogen in the presence of carbon combines with vanadium and niobium to form carbonitrides, which are effective to improve creep rupture strength and are extremely stable thermally. Furthermore, nitrogen stabilizes austenite and greatly mitigates the formation of sigma-ferrite. Increasing nitrogen content in the inventive alloy to a level greater than 0.25% by weight may degrade formability through the formation of coarse nitride particles. Creep rupture strength may be correspondingly lowered as are ductility and toughness. Accordingly, addition of nitrogen in the range of from 0.05 to 0.25 wt %, preferably 0.1 to 0.2 wt %, improved high temperature oxidation resistance and improved the fine dendritic carbide structure of an iron based alloy. Carbon and nitrogen together with vanadium, niobium and tantalum generate MX carbides to slow down dislocation movement.

Aluminum (Al) additionally increases the oxidation resistance and is therefore an important factor in minimizing oxide layer thickness (<40 μm). This significantly reduces the susceptibility to cracks, which has a damaging effect on the basis of the different thermal expansion coefficients (oxide layer-base material).

The material composition is free of sigma phases (embrittlement phases) up to 1080° C. At the same time, this alloy provides resistance to intercrystalline corrosion.

Tests have demonstrated that the alloy of the present invention is suitable as a high-temperature alloy for use in applications such as turbine housings with gas inlet temperatures of 1100° C. and with increased resistance for the following influences:

Thermal shock resistance: No temperature induced cracks in the exhaust gas inlet channel >60% of the wall thickness in the pulling canal.

Oxidation resistance: <60 μm.

No continuous cracks in the turbine housing: up to 1080° C.

Upon penetration of cooling water: acceptable influence on thermal cracking and high temperature corrosion

Test medium: Otto motor exhaust (including ethanol E100)

Dynamically acceptable expansion behavior: >10%<25%

Reduction of dendritic oxidation along the grain boundary with a depth <40 μm: up to 1100° C.

TMF performance verified (after a thermal shock test on the ATL combustion chamber the perfect thermodynamic release performance is to be ensured even after 300 h, load specification OEM): up to 1080° C.

Low cycle fatigue performance:

| | |
|---|---|
| Hot tensile strength at 1000° C. | >105 MPa |
| Hot draw limit at 1000° C. | >70 Mpa |

Since this is an austenitic material, particular attention has to be paid to the high-temperature oxidation and therefore it is desired to achieve an oxidation rate of max. 60 μm, at a component temperature of 1050° C.

The validation test series for this material composition includes the following series:

Oxidation resistance test in simulated Otto exhaust (1010° C.)

Thermal shock at the motor: 300 h without continuous (through-going) cracks, or cracks max. depth 1.5 mm. Tongue area excluded.

Hot gas corrosion test in the furnace: 350 h-1050° C.—oxidation rate: <60 μm

Strauss test according to DIN EN ISO 3651-2 (formerly DIN 50917)

Creep and rupture test up to 1000° C.

The chemical analysis of the material: C: 0.3-0.6; Ni: 27.5-30%;%; Cr: 24-27%; Mn: max. 2%; Si: 1.5-2.4%; Nb: 0.7-1%; Cer: max. 0.40%; V: 0.4-0.6%; Al: 0.7 max; N 0.1-0.2%;

B: max. 0.05%; rest iron.

Mechanical properties of the material:
Rm:>420 MPa
Rp 0.2:>220 MPa
elongation:>6%
Hardness: 180-265 HB
coefficient of elongation: 16.5-18.5 -1/K (20-900° C.)
thermal resistance at 700° C.:
Rm>345 MPa
Rp 0.2>180 MPa Warm strength at 800° C.:
Rm>270 MPa
Rp 0.2>140 MPa Warm strength at 900° C.:
Rm>180 MPa
Rp 0.2>125 MPa
Heat resistance at 1000° C.:
Rm>105 MPa
Rp 0.2>70 MPa High Temperature Strength at 1050° C.:—Rnn>78 MPa
Rp 0.2>45 MPa Heat treatment:
Aging at 1050° C./4-6 h—Air cooling (secondary precipitates are generated)

Without being bound by any particular theory, it is believed that when Rm>105 Mpa cracks and embrittlement are unlikely to occur since when the material is reluctant to being pulled apart macroscopically.

Welding process:

The materials are to be welded using TIG—plasma as well as EB—methods. Production method:
Sand casting
Precision casting.

While not being bound to any particular theory of the invention, it is believed that the effect of the present invention may be attributable to the following:

1.) The cyclic oxidation resistance of the component prevents high-temperature corrosion (with transcrystalline cracking through the grain structure). This is avoided by the chemical composition of the new material, particularly by the mode of action of the combination of element Cr+Si+B+N.

2.) The creep behavior of this high-temperature alloy is generated by interplay of the carbide generators Cr−V−Nb, the nitride former N, and the fine dendritic structure and the adjusted grain size of 2-4 μm by ASTM.

3.) The temperature change resistance, i.e., thermo-mechanical fatigue (TMF) loading performance, is determined mainly by the strength of the elements Cr+V+Nb and the proportion of nickel, adjusted to the total chemistry, in the wt % ratio 0.9 to 1. As a further determinant for this stability, the finely defined nitride formations in the matrix, as well as very small dispersion—precipitation phases (by boron), are located at the grain boundaries, which form strong atomic bonds and thus act against early lattice gliding.

### EXAMPLE AND COMPARATIVE EXAMPLE

The chemical analysis of the material in wt. %:

| Element | Example | Comparative Example |
|---|---|---|
| C: | 0.37 | 0.25-0.4 |
| Ni: | 29.4 | 24-26 |
| Cr: | 24.6 | 24-26 |
| Mn: | 1.2 | 1.0 |
| Si: | 2.0 | 0.7-1.5 |
| Nb: | 0.89 | 1.8-1.5 (incl. Ta) |
| Ce: | 0.0 | 0.0 |
| V: | 0.45 | 0.5-1.5 |
| Al: | 0.0 | 0.0 |
| N | 0.10 | 0.0 |
| P | 0.011 | — |
| S | 0.009 | — |
| B: | 0.0002 | — |
| W: | 0.0 | 2.5-3.5 |
| Fe: | rest | rest |

Mechanical testing of the Example produced the following results:

| | | | Elastic | | | |
|---|---|---|---|---|---|---|
| | | | Limit/ | | | |
| | | | Tension | Tensile | | |
| | Sample | Test | Yield Point | Strength | Elongation | |
| | Diameter | Temperature | Rp0,2 | Rm | at Break | E-Modulus E |
| Sample | [mm] | [° C.] | [MPa] | [MPa] | [%] | [GPa] |
| 1 | Ø7.84 | 20 | 245 | 464 | 8.4 | 155 |
| 2 | Ø7.97 | 20 | 263 | 477 | 7.6 | 167 |
| 3 | Ø8.00 | 20 | 256 | 461 | 7.3 | 136 |
| 4 | Ø7.98 | 800 | — | 283 | — | — |
| 5 | Ø8.04 | 800 | 153 | 303 | 22.3 | 113 |
| 6 | Ø8.01 | 800 | 155 | 305 | 22.0 | 124 |
| 7 | Ø7.88 | 900 | 148 | 207 | 26.3 | 134 |
| 8 | Ø7.98 | 900 | 139 | 194 | 29.9 | 81 |
| 9 | Ø7.95 | 900 | 139 | 197 | 26.3 | 96 |
| 10 | Ø8.03 | 1000 | 83 | 122 | 40.3 | 99 |
| 11 | Ø8.04 | 1000 | 82 | 122 | 26.8 | 103 |
| 12 | Ø7.99 | 1000 | 80 | 117 | 37.7 | 88 |
| 13 | Ø7.91 | 1050 | 58 | 88 | 37.1 | 73 |
| 14 | Ø8.05 | 1050 | 54 | 98 | 28.0 | 93 |
| 15 | Ø8.02 | 1050 | 68 | 98 | 33.8 | 84 |

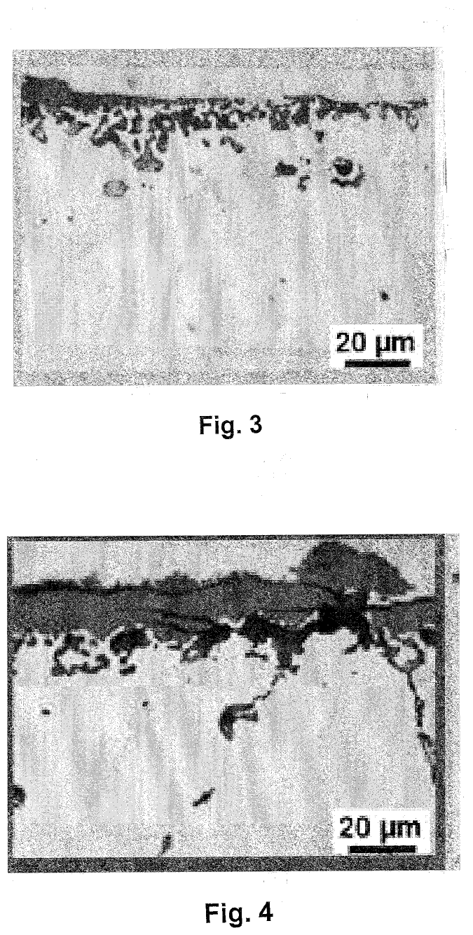

The alloy composition of a tested inventive Example is set forth above. A close commercial alloy was analyzed and results are set forth above. The Example was in the form of a cast disk. A Comparative Example was prepared in the form of a cast rod and separately in the form of a MIM disc. Samples are cut sectioned and the cut surfaces polished with 1200 grit, and cleaned with ethanol in an ultrasonic bath. After drying, the samples were weighed and placed in an oven. The samples were subjected to isothermic conditions of 1010° C. under simulated Otto exhaust for 350 hours. Heating and cooling took place in argon. After exposure the samples were again weighed and it was determined that Example alloy weighing 4.86 gram and having 5 cm² exposed surface area prior to oxidation lost 0.162676628% in weight while the Comparative Example alloy in the form of a cast rod weighing 1.88 gram and having an exposed surface area of 2.2 cm² gained 0.218557732% in weight. A separate Comparative Example in the form of a MIM disk weighing 2.16 gram and having 3.2 cm² exposed surface area gained 0.088940359% in weight was tested. Since oxidation takes place only in the very surface layer of the sample, this slight difference in weight is actually quite significant. A pictomicrograph of the oxidation layer of the unpolished flat surface of the disc is shown in FIG. 3. A pictomicrograph of the oxidation layer of the unpolished circumferential surface of the cast rod with the alloy of Comparative Example is shown in FIG. 3.

The alloy may be cast to form a turbocharger turbine housing. After casting, the housing may be subjected to “Case Hardening”—carburizing, nitriding, carbonitriding and/or boronizing for further hardening the outer portion of the housing a metal can be hardened by the formation of phases which are harder.

Now that the invention has been described, I claim:

1. An iron-based alloy having an austenitic base structure comprising a carbide structure, consisting of the following elements;
C: 0.3 to 0.6% by weight,
Cr: 24 to 27% by weight,
Mn: up to and including 2.0% by weight,
Si: 1.5 to 2.4% by weight,
Nb: 0.7 to 1.0% by weight,
Ni: 27.5 to 30% by weight,
V: 0.4-0.6% by weight,
N: 0.05-0.25% by weight,
Ce: up to 0.4
Mn: up to 2.0
Al: up to 0.7
B: up to 0.05
Fe: balance to make 100% by weight.

2. The iron-based alloy as claimed in claim 1, wherein the nitrogen content is from 0.08-0.12% by weight.

3. The iron-based alloy as claimed in claim 1, wherein the nitrogen content is from 0.1-0.2% by weight.

4. An iron-based alloy having an austenitic base structure comprising a carbide structure, consisting of the following elements;
C: 0.3 to 0.6% by weight,
Cr: 24 to 27% by weight,
Mn: up to and including 2.0% by weight,
Si: 1.5 to 2.4% by weight,
Nb: 0.7 to 1.0% by weight,
Ni: 27.5 to 30% by weight,
V: 0.4-0.6% by weight,
N: 0.08-2.0% by weight,
Ce: up to 0.4
Mn: up to 2.0
Al: up to 0.7
B: up to 0.05
Fe: balance to make 100% by weight.

5. The iron-based alloy as claimed in claim 1, wherein iron-based alloy is substantially free of sigma phases.

6. An exhaust gas turbocharger having an exhaust gas turbine of which the housing is comprised of the iron based alloy of claim 1.

7. A method of increasing oxidation resistance and reducing crack formation in a turbocharger turbine housing, the method comprising
casting a turbine housing comprising the alloy of claim 1, and
assembling the cast turbine housing to a turbocharger.
